(19) United States
(12) Patent Application Publication
(10) Pub. No.: US 2011/0043749 A1
(43) Pub. Date: Feb. 24, 2011

(54) MAGNETIZED EYEWEAR AND MATCHING PICTURE FRAME

(76) Inventor: Kirstie Louise Alley, Los Angeles, CA (US)

Correspondence Address: Kirstie Alley, PO Box 27638, Los Angeles, CA, 90027, US

(21) Appl. No.: 12/691,354

(22) Filed: Jan. 21, 2010

Related U.S. Application Data
(60) Provisional application No. 61/236,026, filed on Aug. 21, 2009.

(51) Int. Cl. G02C 5/14; F16M 13/00; F16M 13/02; G02C 11/00

(52) U.S. Cl. 351/111; 248/206.5; 351/158

(57) ABSTRACT

Magnetized eyewear includes: an article, such eyewear, to be removably worn by the person; and a magnet, fixed to the article, adapted to magnetically store the article. The person wears the article, removes the article, and utilizes the magnet to magnetically store the device. The magnet may be stored in the temple of the eyewear. Also included is a matching picture frame with magnetic material to store the eyewear.

### RELATED APPLICATIONS

The present application claims benefit of priority from U.S. Provisional Application No. 61/236,026, filed Aug. 21, 2009, which is incorporated herein by reference in its entirety.

### BACKGROUND OF THE INVENTION

The present invention generally relates to magnetic storage, and more specifically, to magnetized eyewear and a matching picture frame.

People who wear reading glasses and/or sun glasses complain of losing them constantly, of not being able to find them when they need them, or of having them scratched up by being thrown in a purse or in a drawer. People also have picture frames on tables, desks, nightstands etc.

As can be seen, there is a need for magnetized eyewear, and a picture frame to magnetically store the eyewear.

### SUMMARY OF THE INVENTION

In one aspect of the present invention, a device to be worn by a person and then magnetically stored includes: an article to be removably worn by the person; and a magnet, fixed to the article, adapted to magnetically store the article; wherein the person wears the article, removes the article, and utilizes the magnet to magnetically store the device.

In another aspect of the present invention, a system for storable eyewear includes: eyewear having a temple; and a magnet, integrated into the temple, adapted to magnetically store the eyewear.

In yet another embodiment of the present invention, a method of storing an article for personal use includes: fixing a magnet to the article; using the article for personal use; ceasing use of the article; providing a magnetic storage surface; and placing the article adjacent the magnetic storage surface to magnetically engage the magnet with the surface; thereby storing the article.

These and other features, aspects and advantages of the present invention will become better understood with reference to the following drawings, description and claims.

### BRIEF DESCRIPTION OF THE DRAWINGS

FIG. 1 depicts an embodiment of eyewear according to the present invention;

FIG. 2 depicts a front view of an embodiment of eyewear with picture frame according to the present invention; and

FIG. 3 depicts a rear view of an embodiment of eyewear being stored on the picture frame of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides magnetized reading glasses that may be packaged with a matching picture frame for the glasses to stick to the frame. The glasses are magnetized so when you remove them they can adhere to the picture frame on a desk, table, office, or kitchen, etc. An embodiment may be packaged with a picture frame having a metal back stand.

Embodiments of the present invention may be called “Looky-Lous” and may help prevent losing of endless pairs of reading glasses, thus providing convenience and cost savings.

An embodiment of the present invention includes eyewear, including (but not limited to) reading glasses, sunglasses, and prescription spectacles, having an integrated magnet. An embodiment has a magnet in one or both of the upper parts of the glass's arms or temples. This magnet may attach to the back of a designer picture frame, having a decorative pattern that matches the glasses. The back easel arm that supports the picture when opened may be metal covered with a thin coat of leather. The reading glasses or frame or both are magnetized so they will be held in place on the metal easel arm. The reading/sunglasses may be custom designed to match the picture frames.

An embodiment includes a magnet in the upper part of the arm of the reading glasses. It may look like a little plaque with a logo or designer signature on it, or sections of the arm or the entire arm may be magnetized. The permanent magnet is attracted to magnetic material on the supporting stand of a picture frame. Other embodiments may locate the magnet elsewhere, such as the front of the glasses or in the picture frame. Yet other embodiments are not limited to eyewear, but may include anything worn by a person that is worn and then taken off for storage.

An embodiment may include including a magnet inside the upper arm of a pair of reading glasses. The magnet may be a permanent magnet, such as a ferromagnet. Other embodiments may include a magnet, eyewear temple, or kit that is added to existing glasses. The back of the frame may be table sized, approximately (but not limited to) 5″×7″ or 8″×10,″ including magnetic metal, such as iron or nickel, allowing the reading glasses to be placed on the metal and stay there hidden. It helps a person know where his or her reading glasses are without the glasses getting scratched. The frame may be for pictures or any retainer for the glasses that might be positioned near where someone would want to store his or her glasses, e.g. a frame for E-photos, documents, or art. Other embodiments may include vases or other decorative or useful items that might be found where someone would want to magnetically store glasses or other wearable items.

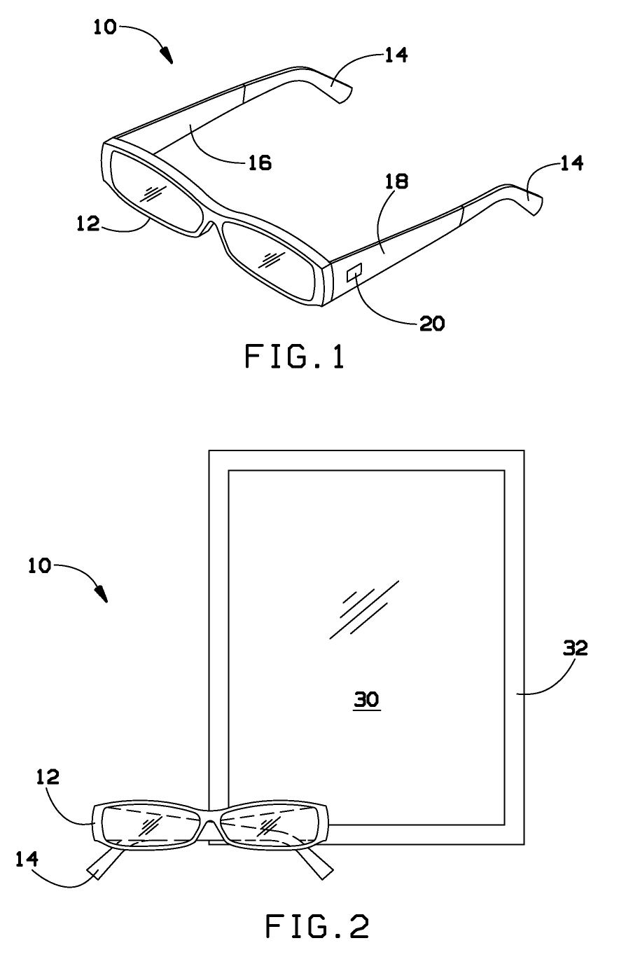

As depicted in FIG. 1, an embodiment of eyewear 10 includes glasses 12, having two arms 14, and one or both arms 14 have a magnet 16. The magnet 16 or other portions of the eyewear may have a decorative pattern 18. The glasses 12 could be reading glasses, sunglasses, prescription spectacles, or other eyewear having arms or templates. The decorative pattern 18 may include a designer logo 20, such as “KA” for Kirstie Alley(TM).

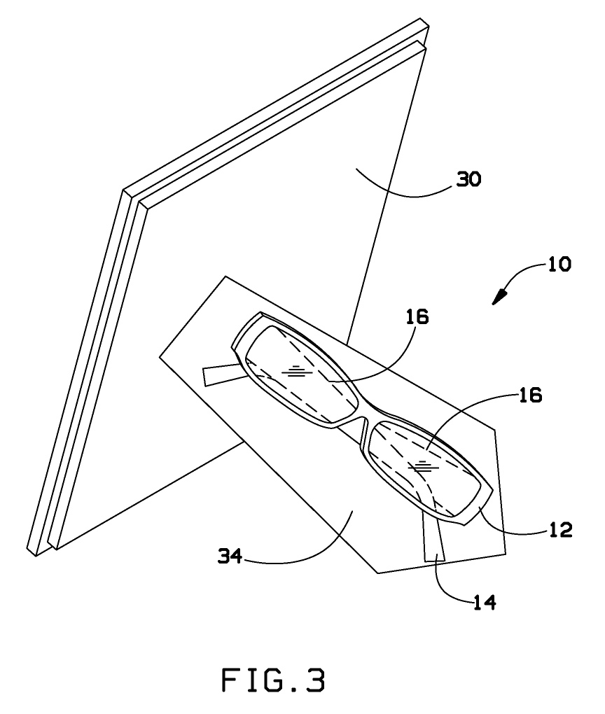

As depicted in FIG. 2, an embodiment of the invention includes eyewear 10 with a decorative pattern 18 and a picture frame 30 with a matching decorative pattern 32. Parts of the frame may be made of magnetic material, so that the eyewear will magnetically adhere to the frame.

As depicted in FIG. 3, an embodiment of the picture frame 30 includes a stand 34 or arm in the back to support the frame, made of magnetic material so that the magnet 16 in the eyewear 10 will adhere to the stand 34. The stand 34 could be covered with decorative material, such as leather. The stand 34 could be positioned on the back of the frame 30 so that, when the magnet 16 is attached to the stand 34, the eyewear 10 is generally hidden from view behind the frame.

To make an embodiment, manufacture the glasses and put a magnetized plaque inset in the upper arm of the glasses. The picture frame's supporting stand or arm is made of metal that adheres to the magnetic glasses.

To use an embodiment, a person might be reading in bed, and when finished, would fold the reading glasses and place them behind the picture frame beside the bed. The magnet would hold them snug and scratch free until they were needed again.

It should be understood, of course, that the foregoing relates to exemplary embodiments of the invention and that modifications may be made without departing from the spirit and scope of the invention as set forth in the following claims.

We claim:

1. A device to be worn by a person and then magnetically stored, comprising:
an article to be removably worn by the person; and
a magnet, fixed to the article, adapted to magnetically store the article;
wherein the person wears the article, removes the article, and utilizes the magnet to magnetically store the device.

2. The device of claim 1, wherein the article is eyewear.

3. The device of claim 1, wherein the article is spectacles having a temple, and the magnet is integrated into the temple.

4. The device of claim 1, wherein the article is spectacles, further comprising:
a first temple, the magnet integrated into the first temple; and
a second temple, having a second magnet integrated into the second temple.

5. The device of claim 1, wherein the article includes a visual indication of the location of the magnet.

6. The device of claim 1, wherein the article is eyewear having a temple, and the magnet is contained by a portion of the temple having a decorative pattern that indicates the location of the magnet.

7. The device of claim 1, further comprising:
a retainer that includes magnetic material;
wherein the person utilizes the magnet to adhere the article to the magnetic material, thereby magnetically storing the article against the retainer.

8. The device of claim 7, wherein the retainer is a frame, and the frame includes a stand having the magnetic material, the stand located on the back of the frame so that, when the article is magnetically stored against the stand, the frame blocks a view of the article.

9. The device of claim 7, wherein the article includes a first decorative pattern and the retainer includes a second decorative pattern that matches the first decorative pattern, thereby indicating that the article may be magnetically stored against the retainer.

10. A system for storable eyewear, comprising:
eyewear having a temple; and
a magnet, integrated into the temple, adapted to magnetically store the eyewear.

11. The system of claim 10, further comprising:
a retainer including magnetic material, adapted to magnetically engage with the magnet so as to releasably retain the eyewear.

12. The system of claim 11, wherein the retainer is a frame having a stand, the stand includes the magnetic material, and when stored, the frame blocks the view of the eyewear.

13. A method of storing an article for personal use, comprising:
fixing a magnet to the article;
using the article for personal use;
ceasing use of the article;
providing a magnetic storage surface; and
placing the article adjacent the magnetic storage surface to magnetically engage the magnet with the surface;
thereby storing the article.

14. The method of claim 13, wherein the article is eyewear, and the magnet is fixed to a temple of the eyewear.

15. The method of claim 13, further comprising:
providing a frame having a display side and a back side, the magnetic storage surface on the back side;
thereby storing the article on the back side of the frame.
